(19) United States
(12) Patent Application Publication
(10) Pub. No.: US 2006/0142938 A1
(43) Pub. Date: Jun. 29, 2006

(54) Inertia position system

(75) Inventors: Chih-Hung Lin, Jhonghe City (TW); Chih-Sheng Chang, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/115,266

(22) Filed: Apr. 27, 2005

(30) Foreign Application Priority Data
Dec. 28, 2004 (TW) 093141020

(51) Int. Cl. G01C 21/00

(52) U.S. Cl. 701/207; 701/220

(57) ABSTRACT

An inertial positioning system is disclosed, which includes at least one sensor, an inertial processing unit, a step-distance determination module, a external positioning module, a Kalman filter and an output terminal, wherein the step-distance determinate module estimates an inertial step-distance via analyzing peak values of velocity and time intervals, and in addition, the external positioning module provides a precise initial state to effectively constrain error of the estimated step-distance.

### BACKGROUND OF THE INVENTION

1. Field of the Invention

The present invention relates to an inertial positioning system and, more particularly, to an inertial positioning system that can position precisely.

2. Description of Related Art

Currently, an external positioning systems (EPS) can be implemented by several technologies such as a global positioning system (GPS), a wireless LAN (WLAN), or enhanced observed time difference (E-OTD). Since the positioning is made via external signals, the receiving of the positioning signals is not reliable; for example, when a positioning device is on a movable object under a shielding, such as a building or a forest, the external positioning system can not correctly receive the positioning signal because of masking from the building or bad weather, which results in the positioning service ceasing to provide accurate and reliable information.

Besides, the external positioning system does have a capability of sensing rotation on a same position. The external positioning system estimates the moveable object's position based on the difference of the continuous movement between two points. When the moveable object rotates on a same position, since the moveable object does not change position or has not much movement, the external positioning system cannot estimate the directional change of the moveable object. Therefore, when the moveable object moves under a shielding, it is possible for the external positioning system to make positioning error if the moveable object has changed in its direction.

In conclusion, a complete positioning system has to include both systems: the external positioning system and the inertial positioning system. The inertial positioning system calculates the difference of movement to determine the moveable object's position via sensing the inertial change of movement and rotation from the moveable object. Therefore, it can continuously provide the positioning information of the object.

However, the error from the inertial positioning system is accumulative, and needs to be corrected by the external positioning system. A moveable object may move into a building or a forest, and due to the subsequent lack of external positioning signals for correction over a long time, the position information of the inertial positioning system will lose its proper accuracy because of accumulative errors. Therefore, the inertial positioning system needs an inner, self-correction mechanism for solving the problem of accumulative errors arising from lack of external positioning signal for a long time.

With reference to FIG. 1, U.S. Pat. No. 6,522,266 with the title “NAVIGATING SYSTEM, METHOD AND SOFTWARE FOR FOOT TRAVEL” describes a conventional inertial positioning system 500 which includes a processor 404, sensors 410 having inertial navigating sensors 414 and magnetic sensors 418, a d-GPS module 510, an altimeter 520 and an output terminal 460, wherein the sensors 410 are used to sense the displacement of a traveler; the processor 404 has an inertial processing unit 430, a motion classifier 420 and a Kalman filter 440.

The motion classifier 420 described above is used to classify the exercise models for determining a traveled distance, however, it does not work effectively in implementation since the classifier 420 needs to go through the classified learning process. The d-GPS module 510 described above is used to differentiate GPS signals to provide an initial position and corrections, and it must go through a ground receiver to receive the GPS satellites signals, thereafter transferring to the receiver on the traveler to provide external positioning data (e.g., initial state). However, such a system is costly due to a registration service with the broadcast stations.

Therefore, it is desirable to provide an inertial positioning system without classifying and learning to estimate a more precise step-distance to mitigate and/or obviate the aforementioned problems.

### SUMMARY OF THE INVENTION

The first object of the present invention is to provide an inertial positioning system so as to avoid error estimation because of a complex or not obvious exercise signal.

It is another object of the present invention to provide an inertial positioning system without classifying and learning so as to estimate a particularly precise step-distance and restrain scattering of error without extra classifying and learning.

It is another object of the present invention to provide an inertial positioning system so as to utilize an external positioning module for providing a precise initial state and error covariance for correction.

In one aspect of the invention, the inertial positioning system of the present invention is provided. The system comprises: at least one sensor, providing at least one motion signal; an inertial processing unit, coupling to the at least one sensor and receiving the at least one motion signal to estimate a step-distance, wherein the inertial processing unit can provide the at least one reference data for calculation; a step-distance determination module, coupling to the inertial processing unit and receiving the estimated step-distance and the at least one reference data to provide an error correction parameter; an external positioning module, providing a position data; a position mapping module, coupling to the external positioning module and providing an initial state based on the position data; and a Kalman filter, receiving the estimated step-distance, the error correction parameter and the initial state, thereby processing them to provide at least one feedback parameter to the inertial processing unit and the step-distance determination module, wherein the Kalman filter transfers the estimated step-distance to the output terminal so that the output terminal can display the estimated step-distance.

In another aspect of the invention, the inertial positioning system of the present invention is provided. The system comprises: at least one sensor, providing at least one motion signal; an inertial processing unit, coupling to the at least one sensor and receiving the at least one motion signal to estimate a step-distance, wherein the inertial processing unit can provide the at least one reference data for calculation; a step-distance determination module, coupling to the inertial processing unit and receiving the estimated step-distance and the at least one reference data, wherein the step-distance determination module derives the at least one peak value of velocity and the at least one time interval from the at least one reference data, thereby via a step-distance determination method provides an error correction parameter; an external positioning module, providing a position data; a position mapping module coupling to the external positioning module and providing an initial state based on the position data; and a Kalman filter receiving the estimated step-distance, the error correction parameter and the initial state, thereby processing them to provide at least one feedback parameter to the inertial processing unit and the step-distance determination module, wherein the Kalman filter transfers the estimated step-distance to the output terminal so that the output terminal can display the estimated step-distance.

Other objects, advantages, and novel features of the invention will become more apparent from the following detailed description when taken in conjunction with the accompanying drawings.

### BRIEF DESCRIPTION OF THE DRAWINGS

FIG. 1 shows a block diagram according to a conventional inertial positioning system;

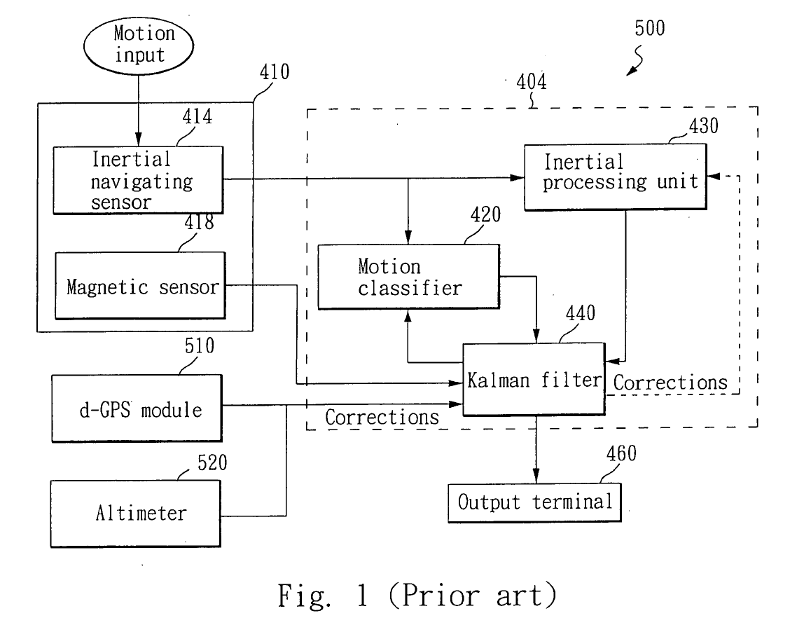

FIG. 2 shows a block diagram of the present invention;

FIG. 3 shows a graph that describes an estimation of a step-distance of a preferred embodiment of the present invention;

FIG. 4 shows a graph that illustrates a simulation of a second-order exponential decline equation model for estimating a step-distance of a preferred embodiment of the present invention; and

FIG. 5 shows a diagram that illustrates the operation of an RFID module of a preferred embodiment of the present invention.

### DETAILED DESCRIPTION OF THE PREFERRED EMBODIMENT

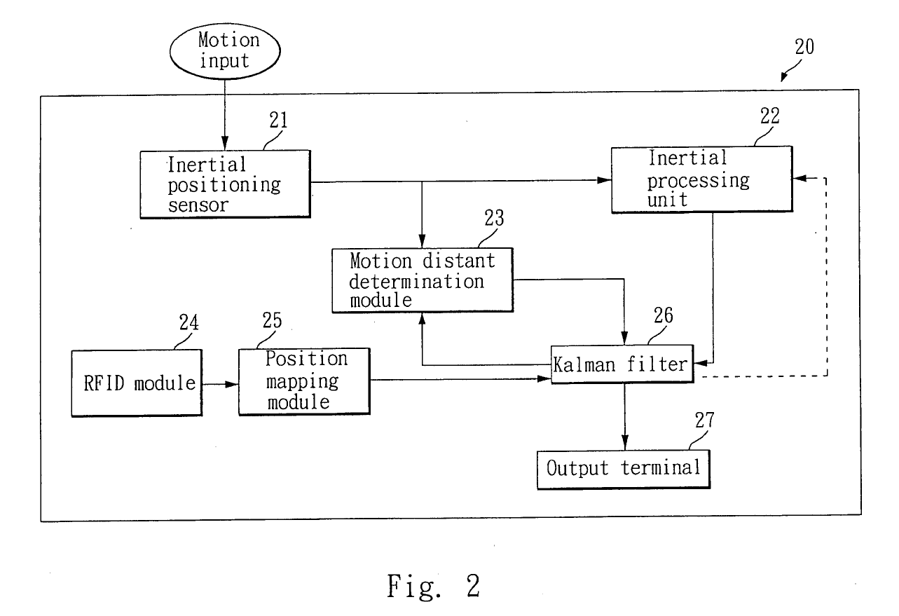

With reference to FIG. 2 that illustrates system functions of a preferred embodiment of the present invention, the inertial positioning system 20 includes inertial positioning sensors 21, an inertial processing unit 22, a step-distance determination module 23, an external positioning module (RFID) 24, a position mapping module 25, a Kalman filter 26 and an output terminal 27.

The inertial positioning sensors 21 as described above are coupled to the inertial processing unit 22; the step-distance determination module 23 is coupled to the inertial processing unit 22 and the Kalman filter 26, respectively; the Kalman filter 26 is coupled to the inertial processing unit 22, the step-distance determination module 23, the position mapping module 25 and the output terminal 27, respectively; the external positioning module 24 is coupled to the position mapping module 25.

The inertial positioning sensors 21 as described above are used to sense the object's displacement and can provide one or more motion signals to the inertial processing unit 22. In this embodiment, a plurality of inertial positioning sensors 21 is provided. In other embodiments, there can be a single inertial positioning sensor 21.

The inertial processing unit 22 as described above is coupled to the inertial positioning sensors 21 and receives the motion signals from the inertial positioning sensors 21, and processes the motion signals to estimate a step-distance. The inertial processing unit 22 also can transfer the processing result of the step-distance to the step-distance determination module 23 and the Kalman filter 26, thereafter displaying the result on the output terminal 27.

The data that the step-distance determination module 23 needs is provided from the inertial processing unit 22. Namely, the step-distance determination module 23 receives the estimated step-distance from the inertial processing unit 22. Furthermore, the inertial processing unit 22 can provide reference data for calculation, such as acceleration, velocity, displacement, angular speed, angular magnitude based on the requirement of the step-distance determination module 23 in order to achieve estimating step-distance function.

When in a case of not receiving external positioning signals for a long time, the step-distance determination module 23 utilizes an estimating step-distance method to provide an extra error correction parameter for the positioning system, and transfers the error correction parameter to the Kalman filter 26 in order to not to scatter the error. In this embodiment, the step-distance determination module 23 implements the estimating step-distance method via a step of analyzing a change of velocity and a step of determining a displacement step-distance.

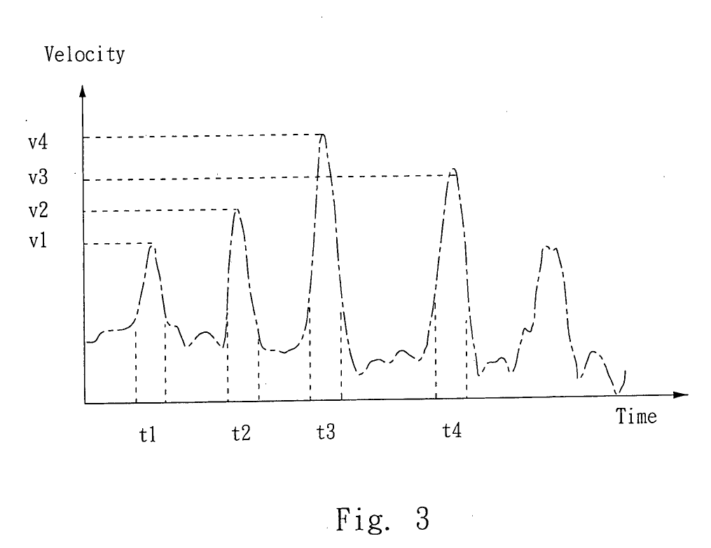

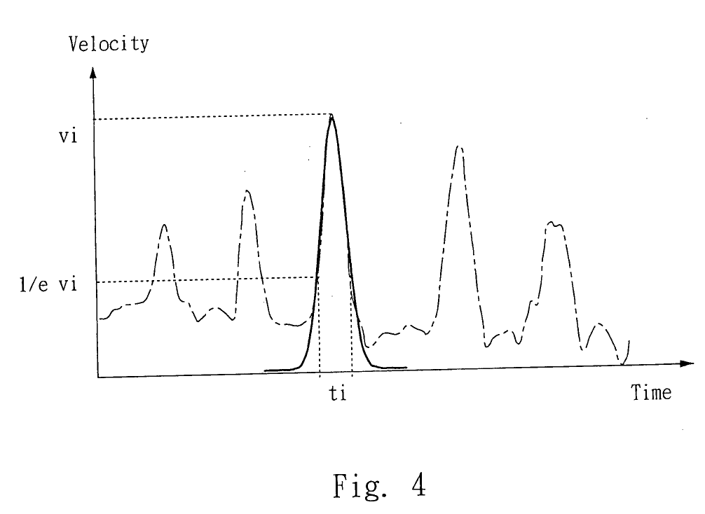

With reference to FIG. 3, it illustrates the step of analyzing change of velocity. Normally, when a person moves, there can be derived a peak value of velocity from the relation of time and velocity. Therefore, there is a displacement step-distance table composed in the step-distance determination module 23, and a displacement step-distance XD of the table uses the peak value of velocity V and the time interval ti as an index value. As it is known that distance equals to velocity multiplying time, using the peak value V as a velocity index, the time interval ti of the peak value V is lowered to the (±) 1/e*V as a time index, as shown in FIG. 4, therefore, the step-distance determination module 23 can derive the object's displacement step-distance XD from knowing the peak value V, and calculating the time interval ti of the peak value V

In this embodiment, the calculation of the displacement step-distance XD is simulated via a Gaussian distribution equation. In other embodiments, there can be a second-order exponential decline model to simulate the calculation of the displacement step-distance XD, as shown in formula (1):
XD=Vᵢ∫e^{-((t/t}^{ᵢ}⁾^{²}⁾dt (1)

In some embodiments, there also may be utilized the direct or indirect data from the inertial measurement to estimate a step-distance and to correct the cumulative error. Since the inertial data would be different depending on the different position on the human body, in this embodiment, the second-order exponential decline model is a correction model from a sensor put on part of the human body, such as the waist.

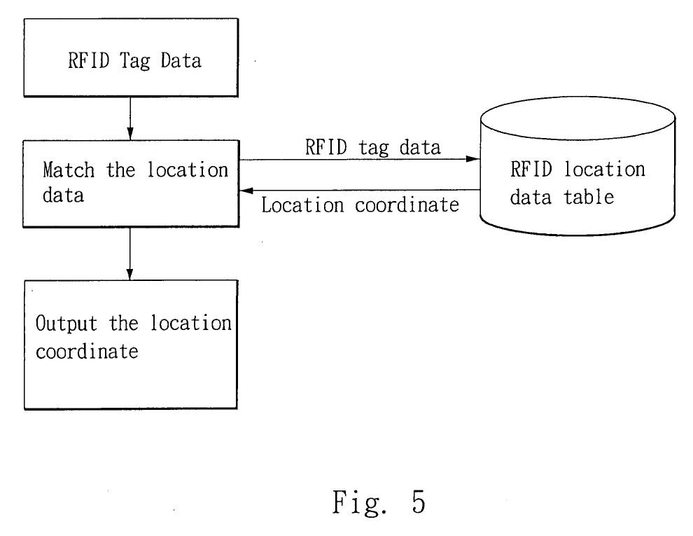

The external positioning module 24 as described above may be a device utilizing actively or passively the airwave, optical or acoustic wave module to provide positioning data. In this embodiment, the external positioning module 24 is a radio frequency identification (RFID) module. In other embodiments, the external positioning module 24 can be an infrared module or a ultrasonic module. Therefore, the external positioning module 24 can provide position data to achieve an initial state (State) and make the Kalman filter 26 processes the error covariance, wherein the initial state including the position and direction, and the direction is made via two neighboring RFID signals. The description below illustrates the external positioning module 24 with an RFID module. With reference to FIG. 5, the external positioning module 24 and the position mapping module 25 are described. In FIG. 5, the external positioning module 24 receives the external RFID tag signals (step S505), and obtains a position data according to the RFID position mapping table and the RFID tag signals (step S510), such that the position data is the object's approximate position (which can be an initial state), and finally, outputs the position data to the Kalman filter 26 (step S515). Since the conventional positioning system is navigated by a technology of GPS or WLAN, the precision of positioning is not perfect and the correction effect is also limited; however, in this embodiment, an error of an estimated step-distance can be effectively corrected by utilizing the RFID to provide more precise positioning.

The Kalman filter 26 is a well-known element to process the circuit gain/loss of the system status simultaneously and to constrain the error scattering. The Kalman filter 26 generates a feedback parameter based on an estimated step-distance calculated by the inertial processing unit 22, an error correction parameter provided by the step-distance determination module 23 and an initial state provided by the external positioning module 24, and returns the feedback parameter to the inertial processing unit 22 and the step-distance determination module 23 to coordinate with and constrain error.

As per the description above, the present invention utilizes an analysis on velocity graphs, which determines a particularly precise displacement step-distance XD via a peak value of velocity V and a time interval ti without classifying and learning. Besides, the present invention can effectively constrain the error of an estimated step-distance via an external positioning module that can provide a particularly precise initial state.

Although the present invention has been explained in relation to its preferred embodiment, it is to be understood that many other possible modifications and variations can be made without departing from the spirit and scope of the invention as hereinafter claimed.

What is claimed is:

1. An inertial positioning system, comprising:
at least one sensor, providing at least one motion signal;
an inertial processing unit, coupling to the at least one sensor and receiving the at least one motion signal to estimate a step-distance, wherein the inertial processing unit can provide the at least one reference data for calculation;
a step-distance determination module, coupling to the inertial processing unit and receiving the estimated step-distance and the at least one reference data to provide an error correction parameter;
an external positioning module, providing a position data;
a position mapping module, coupling to the external positioning module and providing an initial state based on the position data; and
a Kalman filter, receiving the estimated step-distance, the error correction parameter and the initial state, thereby processing them [Safer to write ‘them’ as full nouns.] to provide at least one feedback parameter to the inertial processing unit and the step-distance determination module,
wherein the Kalman filter transfers the estimated step-distance to the output terminal so that the output terminal can display the estimated step-distance.

2. The system as claimed in claim 1, wherein the step-distance determination module provides the error correction parameter based on the at least one reference data to determine the at least one peak value of velocity and the at least one time interval.

3. The system as claimed in claim 1, wherein the external positioning module is an RFID module.

4. The system as claimed in claim 1, wherein the external positioning module is an infrared module.

5. The system as claimed in claim 1, wherein the external positioning module is an ultrasonic module

6. The system as claimed in claim 1, wherein the step-distance determination module provides the error correction parameter via a step of analyzing change of velocity and a step of determining a displacement step-distance.

7. The system as claimed in claim 6, wherein the step of determining a displacement step-distance is derived from an equation of Gaussian distribution.

8. The system as claimed in claim 6, wherein the step of determining a displacement traveled distance is derived from a model of the second-order exponential decline equation.

9. An inertial positioning system, comprising:
at least one sensor, providing at least one motion signal;
an inertial processing unit, coupling to the at least one sensor and receiving the at least one motion signal to estimate a step-distance, wherein the inertial processing unit can provide the at least one reference data for calculation;
a step-distance determination module, coupling to the inertial processing unit and receiving the estimated step-distance and the at least one reference data, wherein the step-distance determination module derives the at least one peak value of velocity and the at least one time interval from the at least one reference data, and an error correction parameter is obtained in accordance with a step-distance determination method;
an external positioning module, providing a position data;
a position mapping module, coupling to the external positioning module and providing an initial state based on the position data; and
a Kalman filter, receiving the estimated step-distance, the error correction parameter and the initial state, thereby processing them to provide at least one feedback parameter to the inertial processing unit and the step-distance determination module,
wherein the Kalman transfers the estimated step-distance to the output terminal so that the output terminal can display the estimated step-distance.

10. The system as claimed in claim 9, wherein the estimating step-distance method includes a step of analyzing change of velocity and a step of determining a displacement step-distance.

11. The system as claimed in claim 10, wherein the step of analyzing change of velocity, the at least one peak value of velocity and the at least one time interval are derived from the at least one reference data.

12. The system as claimed in claim 10, wherein the step of determining a displacement step-distance is derived from an equation of Gaussian distribution.

13. The system as claimed in claim 10, wherein the step of determining a displacement step-distance is derived from a model of the second-order exponential decline equation.

14. The system as claimed in claim 9, wherein the external positioning module is an RFID module.
